(19) United States
(12) Patent Application Publication
(10) Pub. No.: US 2022/0034268 A1
(43) Pub. Date: Feb. 3, 2022

(54) Engines Including Air-Separation Emissions Mitigation Systems and Methods for Operating the Same

(71) Applicant: Saudi Arabian Oil Company, Dhahran (SA)

(72) Inventors: Vallinayagam Raman, Dhahran (SA); Seung-Hak Choi, Dhahran (SA); Junseok Chang, Dhahran (SA)

(73) Assignee: Saudi Arabian Oil Company, Dhahran (SA)

(21) Appl. No.: 17/192,357

(22) Filed: Mar. 4, 2021

Related U.S. Application Data
(60) Provisional application No. 63/059,376, filed on Jul. 31, 2020.

(51) Int. Cl. F02D 41/00; F01N 13/10; F02M 25/00; F01N 3/22; F02M 27/00; F02B 37/12; B01D 53/22; B01F 3/02; B01F 15/02; B01F 15/00

(52) U.S. Cl. CPC F02D 41/0002; F01N 13/10; F02M 25/00; F01N 3/22; F02M 27/00; F02D 41/009; F02D 2200/04; B01D 53/22; B01F 3/026; B01F 15/026; B01F 15/0022; B01F 15/00422; F02B 37/12

(57) ABSTRACT

A method for operating an internal combustion engine includes passing air to a separation unit, separating the air into a nitrogen-enriched air stream and an oxygen-enriched air stream with the separation unit, passing the nitrogen-enriched air stream to a mixing chamber in communication with the separation unit, detecting a nitrogen content within the nitrogen-enriched air stream, based at least in part on the detected nitrogen content within the nitrogen-enriched air stream, moving an air valve between a closed position, in which the air valve restricts flow of an air stream to the mixing chamber, and an open position, in which the air stream flows to the mixing chamber through the air valve, passing the nitrogen-enriched air stream to a combustion chamber, passing a fuel to the combustion chamber, and combusting the fuel and the nitrogen-enriched air stream within the combustion chamber, thereby moving a piston within the combustion chamber.

### CROSS-REFERENCE TO RELATED APPLICATIONS

This application claims the benefit of U.S. Provisional Patent Application 63/059,376 entitled “Engines Including Emissions Mitigation Systems and Methods for Operating the Same” filed Jul. 31, 2020, the contents of which are hereby incorporated by reference in their entirety.

### BACKGROUND

### Field

The present disclosure relates to internal combustion engines including air-separation emissions mitigation systems and methods for operating the same.

### Technical Background

In recent years, various jurisdictions have implemented regulations and agreements to reduce pollutants emitted by engines that use petroleum-based fuels. For example, the International Maritime Organization (IMO) has implemented regulations that relate to marine engine emissions, limiting the emission of pollutants such as sulfur oxides (SOx), nitrogen oxides (NOx), and the like.

### BRIEF SUMMARY

Heavy fuel oil, sometimes referred to as bunker fuel or residual fuel oil, may be utilized in many marine engine applications. In some marine applications, other fuels such as Marine gasoil (MGO), gaseous fuels, and marine renewable synthetic fuels including methanol, ammonia, hydrogen and the like, may be utilized. While efforts are being made to reduce sulfur content in marine fuels (e.g., the IMO 2020 initiative put in place in January of 2020), these marine fuels may include a high sulfur content as compared to other fuels. When marine fuels are combusted, the combustion may emit increased amounts of SOx as compared to other fuels because of the comparatively high sulfur content.

The IMO, as well as other conventions and regulations include emissions mandates that are becoming increasingly restrictive over time, and these conventions present an ongoing challenge to limit SOx emissions and NOx emissions within mandated ranges, particularly in applications that utilize marine fuels. For example, at the time of this disclosure, the Tier 3 IMO NOx regulation is currently in place that mandates an 80% reduction in NOx emission when compared to Tier 1 standards that were applied in January of 2000. The limit for NOx emissions based on the IMO International Convention for the Prevention of Pollution from Ships (MARPOL) Annex VI regulation 13 are, at the time of this disclosure, as follows: Tier 1 (11.3 grams per kilowatt-hour (g/kWh)), Tier 2 (8.9 g/kWh), and Tier 3 (2.2 g/kWh). While Tier 3 NOx regulations are effective in the North American and U.S. Caribbean Sea Emission Control Areas (ECAs) as of 2016, the full-fledged adaptation of Tier 3 NOx regulation is yet to be realized as of the time of this disclosure.

Although emissions mandates with respect to NOx are increasingly restrictive, the comparatively high sulfur content of marine fuels may limit the availability of some NOx emission reduction strategies. For example, the comparatively high sulfur content of marine fuels may be incompatible with exhaust gas recirculation (EGR) systems. Moreover, strategies that are available for use with marine fuels, such as selective catalytic reduction (SCR), may be costly and present other technical challenges, such as ammonia slip.

Accordingly, a need exists for improved internal combustion engines and methods for operating internal combustion engines. More particularly, a need exists for improved combustion engines and methods for operating internal combustion engines that are suitable for use with heavy fuel oil and/or other marine fuels. Embodiments of the present disclosure are directed to internal combustion engines that include a separation unit that separates nitrogen from air, forming a nitrogen-enriched air stream. The nitrogen-enriched air stream may be passed to a combustion chamber, mixed with fuel, and combusted. The nitrogen-enriched air stream may increase a nitrogen content (by volume) in the combustion chamber as compared to conventional configurations, thereby reducing the oxygen content (by volume) in the combustion chamber as compared to conventional configurations. By increasing the nitrogen content and reducing the oxygen content in the combustion chamber, a temperature of the combustion can be reduced, thereby reducing the production of NOx. In some embodiments, the separation unit further produces an oxygen-enriched air stream that can be passed to the combustion chamber or an exhaust manifold. Oxygen within the oxygen-enriched air stream may oxidize unburnt hydrocarbons (HCs) and soot. In this way, internal combustion engines according to the present disclosure may have reduced emissions, even while utilizing heavy fuel oil and/or other marine fuels.

In one embodiment, a method for operating an internal combustion engine includes passing air to a separation unit, separating the air into a nitrogen-enriched air stream and an oxygen-enriched air stream with the separation unit, where the nitrogen-enriched air stream includes a greater concentration of nitrogen than the oxygen-enriched air stream, passing the nitrogen-enriched air stream to a mixing chamber in communication with the separation unit, detecting a nitrogen content within the nitrogen-enriched air stream, based at least in part on the detected nitrogen content within the nitrogen-enriched air stream, moving an air valve between a closed position, in which the air valve restricts flow of an air stream to the mixing chamber, and an open position, in which the air stream flows to the mixing chamber through the air valve, passing the nitrogen-enriched air stream to a combustion chamber, passing a fuel to the combustion chamber, and combusting the fuel and the nitrogen-enriched air stream within the combustion chamber, thereby moving a piston within the combustion chamber.

In another embodiment, a method for operating an internal combustion engine includes passing air to a separation unit, separating the air into a nitrogen-enriched air stream and an oxygen-enriched air stream with the separation unit, where the nitrogen-enriched air stream includes a greater concentration of nitrogen than the oxygen-enriched air stream, passing the nitrogen-enriched air stream to a mixing chamber, mixing the nitrogen-enriched air stream with air within the mixing chamber to form a mixed stream, passing the mixed stream from the mixing chamber to a combustion chamber, passing a fuel to the combustion chamber, and combusting the fuel and the mixed stream within the combustion chamber.

In yet another embodiment, an internal combustion engine includes a combustion chamber, a separation unit in selective communication with the combustion chamber, the separation unit structurally configured to separate air into a nitrogen-enriched air stream and an oxygen-enriched air stream, a compressor in communication with the separation unit, a mixing chamber in communication with the separation unit and in selective communication with the compressor, an air valve in communication with the compressor, where the air valve is positionable between a between a closed position, in which the air valve restricts flow of an air stream from the compressor to the mixing chamber, and an open position, in which the air stream flows to the mixing chamber through the air valve, a nitrogen concentration sensor structurally configured to detect a nitrogen content in the nitrogen-enriched air stream, and a controller communicatively coupled to the air valve and the nitrogen concentration sensor, the controller including a processor and a computer readable and executable instruction set, which when executed, causes the processor to receive a signal from the nitrogen concentration sensor indicative of a detected nitrogen content in the nitrogen-enriched air stream, and direct the air valve to move between the closed position and the open position based at least in part on the signal from the nitrogen concentration sensor.

Additional features and advantages of the technology disclosed in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts an internal combustion engine including a separation unit, according to one or more embodiments shown and described herein;

FIG. 2 schematically depicts a control diagram of the internal combustion engine of FIG. 1, according to one or more embodiments shown and described herein;

FIG. 3 schematically depicts an internal combustion engine including a separation unit and an oxygen-enriched air stream in communication with a combustion chamber, according to one or more embodiments shown and described herein;

FIG. 4 schematically depicts an internal combustion engine including a separation unit and an oxygen-enriched air stream in communication with an exhaust manifold, according to one or more embodiments shown and described herein;

FIG. 5 schematically depicts an internal combustion engine including a separation unit and an oxygen-enriched air stream in communication with a mixing chamber, a combustion chamber, and an exhaust manifold, according to one or more embodiments shown and described herein; and

FIG. 6 schematically depicts a timing chart for the passing of an oxygen-enriched air stream into the exhaust manifold or the combustion chamber, according to one or more embodiments shown and described herein.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

Embodiments of the present disclosure are directed to internal combustion engines that include a separation unit that separates nitrogen from air, forming a nitrogen-enriched air stream. In embodiments, the nitrogen-enriched air stream is passed to a combustion chamber, mixed with a fuel, and combusted. The nitrogen-enriched air stream generally increases the nitrogen content in the combustion chamber during combustion, as compared configurations that do not include a nitrogen-enriched air stream. By increasing the nitrogen content in the combustion chamber during combustion and accordingly decreasing an oxygen content by volume in the combustion chamber, a temperature of the combustion can be reduced as compared to configurations having a lower nitrogen content. By lowering the temperature of combustion, the production of NOx is reduced as compared to configurations having a higher combustion temperature.

In some embodiments, the separation unit further produces an oxygen-enriched air stream that can be passed to the combustion chamber or an exhaust manifold. Oxygen within the oxygen-enriched air stream oxidizes unburnt HCs and soot in the combustion chamber or the exhaust manifold. In this way, internal combustion engines according to the present disclosure may have reduced emissions, such as reduced NOx, reduced unburnt HCs, and reduced soot as compared to conventional configurations even while utilizing heavy fuel oil and/or other marine fuels. These and other embodiments will now be described with reference to the appended drawings.

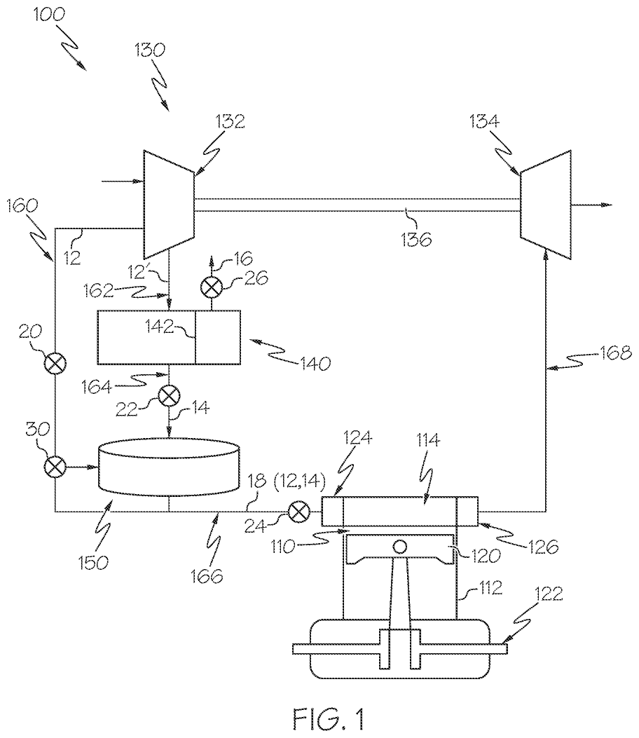

Now referring to FIG. 1, an internal combustion engine 100 is schematically depicted. In the embodiment depicted in FIG. 1, the internal combustion engine 100 includes a compression system 130, a separation unit 140, and a combustion chamber 110.

In the embodiment depicted in FIG. 1, the internal combustion engine 100 includes a cylinder head 114 engaged with a block that defines one or more sidewalls 112 engaged with the cylinder head 114. In embodiments, a piston 120 is engaged with the one or more sidewalls 112. The piston 120, the cylinder head 114, and the one or more sidewalls 112 at least partially define the combustion chamber 110, and fuel may be combusted within the combustion chamber 110. In embodiments, the piston 120 is movable along the one or more sidewalls 112 toward and away from the cylinder head 114, for example, as fuel is combusted within the combustion chamber 110. While in the view depicted in FIG. 1 a single combustion chamber 110 is depicted, it should be understood that the internal combustion engine 100 may include any suitable number of combustion chambers 110 in any suitable orientation with respect to one another. Further, while in the embodiment depicted in FIG. 1, the combustion chamber 110 is depicted as being defined by the cylinder head 114, the one or more sidewalls 112, and the piston 120, it should be understood that this is merely an example, and the internal combustion engine 100 may have any suitable combustion chamber 110. For example, in some applications, the combustion chamber 110 may be defined by a crankcase and a piston that rotates within the crankcase (e.g., a rotary engine configuration).

In embodiments, the piston 120 is coupled to a crankshaft 122. For example in the embodiment depicted in FIG. 1, the piston 120 is coupled to the crankshaft 122 through a connecting rod, and in operation, linear movement of the piston 120 along the one or more sidewalls 112 is converted into rotational movement of the crankshaft 122. In embodiments in which the internal combustion engine 100 is the engine of a marine vessel, the crankshaft 122 may rotate a propeller or the like that provides the vessel with mobility. In embodiments in which the internal combustion engine 100 is the engine of a land-based vehicle, the crankshaft 122 may be coupled to one or more wheels or tracks that provide the vehicle with mobility. In some embodiments, the internal combustion engine 100 may be part of a power generation system, and the crankshaft 122 may drive a generator that produces electrical current.

In embodiments, the combustion chamber 110 is in selective communication with an intake manifold 124 and an exhaust manifold 126. The intake manifold 124 may include any suitable manifold through which intake gas is passed into the combustion chamber 110. In embodiments, the exhaust manifold 126 may include any suitable manifold through which exhaust gases (e.g., combustion by-products from the combustion chamber 110) are passed after fuel is combusted within the combustion chamber 110. In embodiments in which the internal combustion engine 100 includes multiple combustion chambers, the intake manifold 124 and/or the exhaust manifold 126 may be in selective communication with the multiple combustion chambers.

In some embodiments, the internal combustion engine 100 may be in selective communication with the intake manifold 124 through one or more intake valves, and may be in selective communication with the exhaust manifold 126 through one or more exhaust valves. The intake valves and the exhaust valves may each be positionable between an open position and a closed position, and can each be moved between the open position and the closed position by any suitable device, such as and without limitation, a cam shaft, a hydraulic actuator, an electromagnetic actuator, a pneumatic actuator, or the like.

In some embodiments, the internal combustion engine 100 includes the compression system 130. For example, in the embodiment depicted in FIG. 1, the internal combustion engine 100 includes a compression system 130 embodied as a turbocharger including a compressor 132, a turbine 134, and a shaft 136 coupled to the compressor 132 and the turbine 134. The turbine 134 may rotate, for example as the result of exhaust gas being passed through the turbine 134, as described in greater detail herein. As the turbine 134 rotates, the turbine 134 rotates the shaft 136, which in turn rotates the compressor 132. As the compressor 132 rotates, the compressor 132 may compress air that is then passed to the combustion chamber 110. While in the embodiment depicted in FIG. 1, the internal combustion engine 100 includes a turbocharger, it should be understood that this is merely an example, and the compression system 130 may include any suitable compression system, for example and without limitation, a supercharger or the like. Further in some embodiments, the internal combustion engine 100 may include a vacuum pump or the like to draw air to the separation unit 140.

In embodiments, the internal combustion engine 100 includes the separation unit 140. The separation unit 140, in embodiments, is structurally configured to separate nitrogen from air. In embodiments, the separation unit 140 may separate nitrogen from compressed air stream 12′ passed to the separation unit 140, for example, from the compressor 132. The separation unit 140 may separate nitrogen from the compressed air stream 12′ through any suitable process, for example and without limitation, pressure-swing adsorption and/or temperature-swing adsorption, or the like. In some embodiments, the separation unit 140 may include one or more membranes 142 that are structurally configured to separate nitrogen from air. For example, in some embodiments, the one or more membranes 142 may selectively allow oxygen and/or other gases to pass through the one or more membranes 142, while restricting the nitrogen from passing through the one or more membranes 142. The one or more membranes 142 may include any suitable membranes to separate nitrogen from air, and may include, for example and without limitation, hollow fiber membranes, flat sheet membranes, or the like.

In some embodiments, the internal combustion engine 100 may include an air conduit 162 extending between the separation unit 140 and the compressor 132. Once the internal combustion engine 100 is operational, a stream of compressed air stream 12′ from the compressor 132 may flow through the air conduit 162 to the separation unit 140.

As the separation unit 140 separates nitrogen from the compressed air stream 12′, the separation unit 140 forms a nitrogen-enriched air stream 14 and an oxygen-enriched air stream 16. In embodiments, the nitrogen-enriched air stream 14 has a higher concentration of nitrogen than the compressed air stream 12′. In embodiments, the nitrogen-enriched air stream 14 has a higher concentration of nitrogen than ambient air (e.g., air drawn into the compressor 132). The nitrogen-enriched air stream 14, in embodiments, generally includes a greater concentration of nitrogen than the oxygen-enriched air stream 16.

In some embodiments, the nitrogen-enriched air stream 14 may include at least 79.5% nitrogen by volume. In some embodiments, the nitrogen-enriched air stream 14 may include at least 85.0% nitrogen by volume. In some embodiments, the nitrogen-enriched air stream 14 may include at least 87.0% nitrogen by volume. In some embodiments, the nitrogen-enriched air stream 14 may include at least 89.0% nitrogen by volume. In some embodiments, the nitrogen-enriched air stream 14 may include at least 90.0% nitrogen by volume. In some embodiments, the nitrogen-enriched air stream 14 may include at least 95.0% nitrogen by volume. In some embodiments, the nitrogen-enriched air stream 14 may include at least 99.0% nitrogen by volume. In some embodiments, the nitrogen-enriched air stream 14 may include at least 99.5% nitrogen by volume.

In some embodiments, the nitrogen-enriched air stream 14 may include between about 79.5% and about 89.0% nitrogen by volume, inclusive of the end points. In some embodiments, the nitrogen-enriched air stream 14 may include between about 80.0% and about 99.5% nitrogen by volume, inclusive of the end points. In some embodiments, the nitrogen-enriched air stream 14 may include between about 85.0% and about 91.0% nitrogen by volume, inclusive of the end points. In some embodiments, the nitrogen-enriched air stream 14 may include between about 85.0% and about 99.5% nitrogen by volume, inclusive of the end points.

In embodiments, the oxygen-enriched air stream 16 may have a higher oxygen concentration than the compressed air stream 12′. In some embodiments, the oxygen-enriched air stream 16 may have an oxygen concentration between about 22.0% and about 40.0% oxygen by volume, inclusive of the endpoints. In some embodiments, the oxygen-enriched air stream 16 may have an oxygen concentration between about 25.0% and about 40.0% oxygen by volume, inclusive of the endpoints. In some embodiments, the oxygen-enriched air stream 16 may have an oxygen concentration between about 28.5% and about 39.8% oxygen by volume, inclusive of the endpoints.

In the embodiment depicted in FIG. 1, the oxygen-enriched air stream 16 may be vented to atmosphere, for example, through a check valve 26. In embodiments, the check valve 26 may include any suitable one-way valve that allows the oxygen-enriched air stream 16 to pass from the separation unit 140 through the check valve 26, while restricting the flow of gas through the check valve 26 into the separation unit 140.

In some embodiments, the internal combustion engine 100 includes a mixing chamber 150 in communication with the separation unit 140 and the combustion chamber 110. For example, in the embodiment depicted in FIG. 1, the internal combustion engine 100 includes a nitrogen conduit 164 extending between the separation unit 140 and the mixing chamber 150 that allows the nitrogen-enriched air stream 14 to flow from the separation unit 140 to the mixing chamber 150. In some embodiments, the internal combustion engine 100 may include a check valve 22 positioned between the separation unit 140 and the mixing chamber 150. The check valve 22 may include a one-way valve or the like that permits flow of the nitrogen-enriched air stream 14 from the separation unit 140 to the mixing chamber 150 through the check valve 22, but restricts flow of gas from the mixing chamber 150 to the separation unit 140 through the check valve 22.

In some embodiments and as depicted in FIG. 1, compressed air stream 12 from the compressor 132 is directed to the mixing chamber 150 via an air conduit 160. For example, in embodiments, an compressed air stream 12 flows from the compressor 132 to the mixing chamber 150 through the air conduit 160.

In some embodiments, the compressed air stream 12 may mix with the nitrogen-enriched air stream 14 within the mixing chamber 150, as described in greater detail herein. In some embodiments, the compressed air stream 12 may pass from the compressor 132 to the intake manifold 124 and into the combustion chamber 110 without mixing with the nitrogen-enriched air stream 14, for example during a startup procedure in which the separation unit 140 is not yet operational. In embodiments, the compressed air stream 12 may pass through the mixing chamber 150, to the intake manifold 124 and into the combustion chamber 110 without mixing with the nitrogen-enriched air stream 14 in the mixing chamber 150 during startup. In some embodiments, the compressed air stream 12 may bypass the mixing chamber 150 to the intake manifold 124 and the combustion chamber 110 during startup.

For example, in some embodiments, the internal combustion engine 100 includes an compressed air valve 30 positioned between the compressor 132 and the mixing chamber 150, and positioned between the compressor 132 and the intake manifold 124. The compressed air valve 30, in some embodiments, is positionable between a mixing position, and an engine intake position. In the mixing position, the compressed air valve 30 directs the compressed air stream 12 to the mixing chamber 150, while restricting flow of the compressed air stream 12 directly to the intake manifold 124 through the compressed air valve 30. In the engine intake position, the compressed air valve 30 directs the compressed air stream 12 to the intake manifold 124, while restricting flow of the compressed air stream 12 to the mixing chamber 150 through the compressed air valve 30.

In some embodiments, the compressed air valve 30 is positionable between an open position and a closed position. In the open position, the compressed air valve 30 allows the compressed air stream 12 to flow from the compressor 132 to the mixing chamber 150 and/or the intake manifold 124. In the closed position, the compressed air valve 30 restricts flow of the compressed air stream 12 from the compressor 132 to the mixing chamber 150 and the intake manifold 124 through the compressed air valve 30.

In some embodiments, the internal combustion engine 100 includes a check valve 20 positioned between the compressor 132 and the mixing chamber 150, and between the compressor 132 and the intake manifold 124 on the air conduit 160. The check valve 20 may include a one-way valve or the like that permits flow of the compressed air stream 12 from the compressor 132 to the mixing chamber 150 and/or the intake manifold 124, while restricting the flow of gas from the mixing chamber 150 and/or the intake manifold 124 to the compressor 132 through the check valve 20.

The mixing chamber 150, in embodiments, includes a chamber that is suitable to mix gasses received from the separation unit 140 and the compressor 132. In particular, the compressed air stream 12 and the nitrogen-enriched air stream 14 mix within the mixing chamber 150, forming a mixed stream 18 that is a combination of the compressed air stream 12 and the nitrogen-enriched air stream 14. In embodiments, the compressed air stream 12 may generally dilute the concentration of nitrogen in the nitrogen-enriched air stream 14, such that the mixed stream 18 generally has a lower concentration of nitrogen than the nitrogen-enriched air stream 14 alone. In some embodiments, the mixed stream 18 may include at least 79.5% Nitrogen by volume. The mixed stream 18, in some embodiments, may include at least 85.0% Nitrogen by volume. In some embodiments, the mixed stream 18 may include at least 87.0% Nitrogen by volume. The mixed stream 18, in some embodiments, may include at least 89.0% Nitrogen by volume. In some embodiments, the mixed stream 18 may include at least 90.0% Nitrogen by volume. The mixed stream 18, in some embodiments, may include at least 91.0% Nitrogen by volume.

In some embodiments, the mixed stream 18 may include between about 79.5% and about 91.0% Nitrogen by volume, inclusive of the end points. In some embodiments, the mixed stream 18 may include between about 85.0% and about 91.0% Nitrogen by volume, inclusive of the end points. In some embodiments, the mixed stream 18 may include between about 79.5% and about 89.0% Nitrogen by volume, inclusive of the end points.

In embodiments, the mixing chamber 150 is in communication with the intake manifold 124, for example through a conduit 166. Through the conduit 166, in some embodiments, the mixed stream 18 is passed from the mixing chamber 150 to the intake manifold 124. In some embodiments, the internal combustion engine 100 may include a check valve 24 positioned between the mixing chamber 150 and the intake manifold 124 on the conduit 166. In embodiments, the check valve 24 may include a one-way valve or the like that permits the flow of the mixed stream 18 from the mixing chamber 150 to the intake manifold 124 through the check valve 24, while restricting flow of gas from the intake manifold 124 to the mixing chamber 150 through the check valve 24.

From the intake manifold 124, the mixed stream 18 passes into the combustion chamber 110. Fuel may also be passed into the combustion chamber 110, and may be mixed with the mixed stream 18. The mixture of the fuel and the mixed stream 18 is combusted, thereby moving the piston 120. As described above, linear movement of the piston 120 may be converted into rotational movement of the crankshaft 122.

Without being bound by theory, the mixed stream 18 may reduce the temperature of combustion within the combustion chamber 110 as compared to internal combustion engines that combust an air/fuel mixture having a lower nitrogen concentration. For example, air/fuel mixtures having a higher volume percentage of oxygen (and accordingly a lower nitrogen concentration) as compared to the mixed stream 18 may increase the temperature of combustion within the combustion chamber 110.

By reducing the temperature of combustion within the combustion chamber 110, NOx produced by combustion within the combustion chamber 110 may be reduced. In particular, lower combustion temperatures may reduce chemical reactions that lead to the production of NOx. In this way, by generating and combusting a nitrogen-enriched air stream 14 having a comparatively high nitrogen concentration as compared to air, the internal combustion engine 100 may have reduced NOx emissions as compared to conventional combustion engines.

Moreover, by reducing NOx emissions via the nitrogen-enriched air stream 14, internal combustion engines 100 according to the present disclosure may reduce NOx emissions without aftertreatment processes, such as exhaust gas recirculation (EGR) or selective catalyst reduction (SCR).

By reducing NOx emissions without the use of EGR, internal combustion engines 100 according to the present disclosure may reduce NOx emissions while utilizing heavy fuel oil and/or other marine fuels. Without being bound by theory, the comparatively high sulfur content of heavy fuel oil (as compared to other petroleum-based fuels), as well as the amount of soot and/or particulates produced by the combustion of heavy fuel oil make the use of EGR systems with heavy fuel oil difficult. For example, exhaust gases including sulfur, SOx, soot and/or particulates resulting from the combustion of heavy fuel oil may be incompatible for use with EGR systems. Accordingly, by reducing NOx emissions without the use of EGR systems, internal combustion engines 100 according to the present disclosure may reduce NOx emissions while utilizing heavy fuel oil. Furthermore, because NOx emissions can be reduced without the use of EGR systems, internal combustion engines 100 do not require components associated with EGR systems, such as large heat exchangers, reducing the complexity and cost of the internal combustion engines 100.

Further, by reducing NOx emissions without the use of SCR, emissions related to ammonia slip may be avoided. Additionally, by reducing NOx emissions without the use of SCR, the cost and complexity of internal combustion engines 100 according to the present disclosure may be reduced as compared to engines utilizing SCR systems.

Referring still to FIG. 1, exhaust gases produced by the combustion within the combustion chamber 110 are passed to the exhaust manifold 126. At least a portion of the exhaust gases may be passed from the exhaust manifold 126 may be passed to the turbine 134, for example through a conduit 168 extending between the exhaust manifold 126 and the turbine 134. As described above, in embodiments, the exhaust gases may drive the turbine 134 to rotate, thereby rotating the shaft 136, and accordingly thereby rotating the compressor 132.

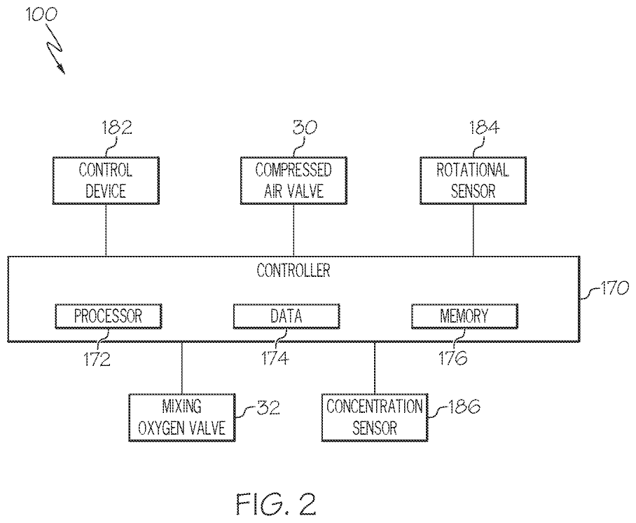

Referring to FIGS. 1 and 2, a control diagram of the internal combustion engine 100 is schematically depicted. In embodiments, the internal combustion engine 100 includes a controller 170. As illustrated, the controller 170 includes a processor 172, a data storage component 174, and/or a memory component 176. The memory component 176 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the controller 170 and/or external to the controller 170.

The memory component 176 may store operating logic, analysis logic, and communication logic in the form of one or more computer readable and executable instruction sets. The analysis logic and the communication logic may each include a plurality of different pieces of logic, each of which may be embodied as a computer program, firmware, and/or hardware, as an example. A local interface may also included in the controller 170, and may be implemented as a bus or other communication interface to facilitate communication among the components of the controller 170.

The processor 172 may include any processing component operable to receive and execute instructions (such as from a data storage component 174 and/or the memory component 176). It should be understood that while the components in FIG. 2 are illustrated as residing within the controller 170, this is merely an example, and in some embodiments, one or more of the components may reside external to the controller 170. It should also be understood that, while the controller 170 is illustrated as a single device, this is also merely an example.

In embodiments, the controller 170 is communicatively coupled to one or more components of the internal combustion engine 100. In some embodiments, the internal combustion engine 100 includes a rotational sensor 184 communicatively coupled to the controller 170. In embodiments, the rotational sensor 184 is structurally configured to detect a rotational position and/or a rotational speed of the crankshaft 122. The rotational sensor 184 may send and/or receive signals from the controller 170. For example, in some embodiments the rotational sensor 184 may send a signal or signals to the controller 170 indicative of a detected rotational position of the crankshaft 122.

In some embodiments, the internal combustion engine 100 includes a nitrogen concentration sensor 186 communicatively coupled to the controller 170. The nitrogen concentration sensor 186, in embodiments, is structurally configured to detect a concentration of nitrogen in gas passing to the intake manifold 124. For example, the nitrogen concentration sensor 186 may detect a content of nitrogen within the nitrogen-enriched air stream 14 passing to the mixing chamber 150 and/or the intake manifold 124. In some embodiments, the nitrogen concentration sensor 186 may detect a content of nitrogen within the mixed stream 18 passing to the intake manifold 124 from the mixing chamber 150. The nitrogen concentration sensor 186, in embodiments, may send and/or receive signals from the controller 170. For example, in some embodiments, the nitrogen concentration sensor 186 sends signals to the controller 170 indicative of the concentration of nitrogen in gas passing to the intake manifold 124.

In some embodiments, the controller 170 is communicatively coupled to the compressed air valve 30. The controller 170 may send and/or receive signals from the compressed air valve 30. For example, in some embodiments, the controller 170 may direct the compressed air valve 30 to move between the open position and the closed position. In some embodiments, the controller 170 may direct the compressed air valve 30 to move between the mixing position and the engine intake position.

The controller 170, in embodiments, may direct the compressed air valve 30 to move between the closed position and the open position based at least in part on a detected nitrogen concentration received from the nitrogen concentration sensor 186. Further, in some embodiments, the controller 170 may direct the compressed air valve 30 to move between the mixing position and the intake position based at least in part on a detected nitrogen concentration received from the nitrogen concentration sensor 186.

For example, in some embodiments, the controller 170 may direct the compressed air valve 30 to move from the open position to the closed position in response to receiving a signal from the nitrogen concentration sensor 186 indicative of a detected nitrogen content in the nitrogen-enriched air stream 14 below a lower configurable threshold. In some embodiments, the lower configurable threshold is about 79.5% nitrogen by volume. In some embodiments, the lower configurable threshold is greater than about 79.5% nitrogen by volume. In some embodiments, the lower configurable threshold is between about 79.5% and about 89.0% by volume, inclusive of the endpoints.

By moving the compressed air valve 30 to the closed position, the compressed air stream 12 may be restricted from flowing to the mixing chamber 150 and mixing with the nitrogen-enriched air stream 14, which may generally increase the nitrogen concentration in gas passing to the combustion chamber 110. In embodiments, with the nitrogen content above the lower configurable threshold, the nitrogen-enriched air stream 14 may be suitable for mixture with fuel for combustion without mixing with the compressed air stream 12.

In some embodiments, in response to the receiving a signal from the nitrogen concentration sensor 186 indicative of a detected nitrogen content in the nitrogen-enriched air stream 14 exceeding an upper configurable threshold, the controller 170 directs the compressed air valve 30 to move from the closed position to the open position. In some embodiments, the upper configurable threshold is about 89.0% by volume. In some embodiments, the upper configurable threshold is less than about 89.0% nitrogen by volume. In some embodiments, the upper configurable threshold is between about 79.5% and about 89.0% by volume, inclusive of the endpoints.

By moving the compressed air valve 30 from the closed position to the open position, the compressed air stream 12 passes to the mixing chamber 150 through the compressed air valve 30. The compressed air stream 12 mixes with the nitrogen-enriched air stream 14 in the mixing chamber 150, thereby forming the mixed stream 18 and diluting the nitrogen content passed to the combustion chamber 110 via the intake manifold 124. By selectively moving the compressed air valve 30 between the open position and the closed position based at least in part on the detected nitrogen content within the nitrogen-enriched air stream 14, the nitrogen content in gas passed to the combustion chamber 110 can be maintained between the upper configurable threshold and the lower configurable threshold. In this way, the controller 170, the compressed air valve 30, and the nitrogen concentration sensor 186 may regulate the nitrogen in gas passed to the combustion chamber 110 between the upper configurable threshold and the lower configurable threshold, which may thereby maintain a temperature of combustion within the combustion chamber 110.

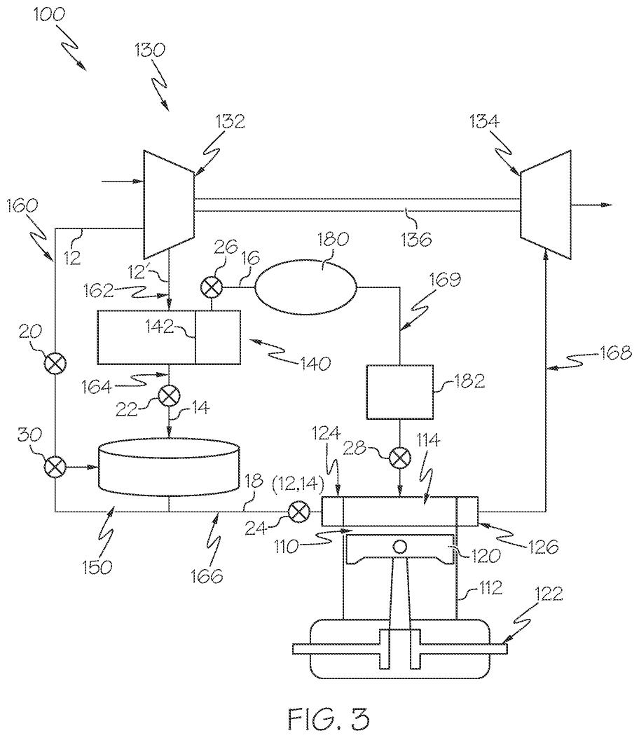

Referring to FIGS. 2 and 3, another embodiment of the internal combustion engine 100 is schematically depicted. Similar to the embodiment depicted in FIG. 1, the internal combustion engine 100 includes the compression system 130, the combustion chamber 110, the separation unit 140, and the mixing chamber 150. However, in the embodiment depicted in FIG. 3, the oxygen-enriched air stream 16 is in selective communication with the combustion chamber 110.

For example, in the embodiment depicted in FIG. 3, the internal combustion engine 100 includes an oxygen conduit 169 extending between the separation unit 140 and the combustion chamber 110. Through the oxygen conduit 169, the oxygen-enriched air stream 16 may be selectively injected into the combustion chamber 110.

In some embodiments, the internal combustion engine 100 includes an oxygen valve 28 positioned on the oxygen conduit 169 between the separation unit 140 and the combustion chamber 110. In some embodiments, the oxygen valve 28 may include a check valve or the like that permits the flow of the oxygen-enriched air stream 16 from the separation unit 140 to the combustion chamber 110, while restricting the flow of gases from the combustion chamber 110 to the separation unit 140.

In some embodiments, the internal combustion engine 100 may include an oxygen stream compressor 180 that is operable to increase a pressure of the oxygen-enriched air stream 16. The oxygen stream compressor 180 may include any suitable compressor, for example and without limitation, a rotary screw compressor, a reciprocating air compressor, an axial compressor, a centrifugal compressor, or the like.

In some embodiments, the internal combustion engine 100 further includes an oxygen stream control device 182 positioned between the separation unit 140 and the combustion chamber 110. In embodiments, the oxygen stream control device 182 is structurally configured to selectively inject the oxygen-enriched air stream 16 into the combustion chamber 110. In some embodiments, the oxygen stream control device 182 injects the oxygen-enriched air stream 16 into the combustion chamber 110 without passing the oxygen-enriched air stream 16 through the intake manifold 124. In embodiments, the oxygen stream control device 182 may include any suitable device for selectively injecting the oxygen-enriched air stream 16 into the combustion chamber 110, for example and without limitation a valve or the like. In the embodiment depicted in FIGS. 2 and 3, the controller 170 is communicatively coupled to the oxygen stream control device 182. In embodiments, the oxygen stream control device 182 may receive and/or receive signals from the controller 170. For example, the controller 170 may send signals to the oxygen stream control device 182 to control the injection of the oxygen-enriched air stream 16 into the combustion chamber 110. In embodiments, the controller 170, the oxygen stream control device 182, and the rotational sensor 184 may coordinate the passage of the oxygen-enriched air stream 16 to the combustion chamber 110, as described in greater detail herein.

By selectively injecting the oxygen-enriched air stream 16 into the combustion chamber 110, soot and/or unburnt HCs may be oxidized. For example, in some embodiments, injection of the oxygen-enriched air stream 16 late in the combustion cycle may encourage oxidation of unburnt HCs and/or soot, as described in greater detail herein. In some embodiments, the oxygen-enriched air stream 16 may be passed into the combustion chamber 110 during an intake stroke to assist in knock mitigation and flame propagation, as described in greater detail herein.

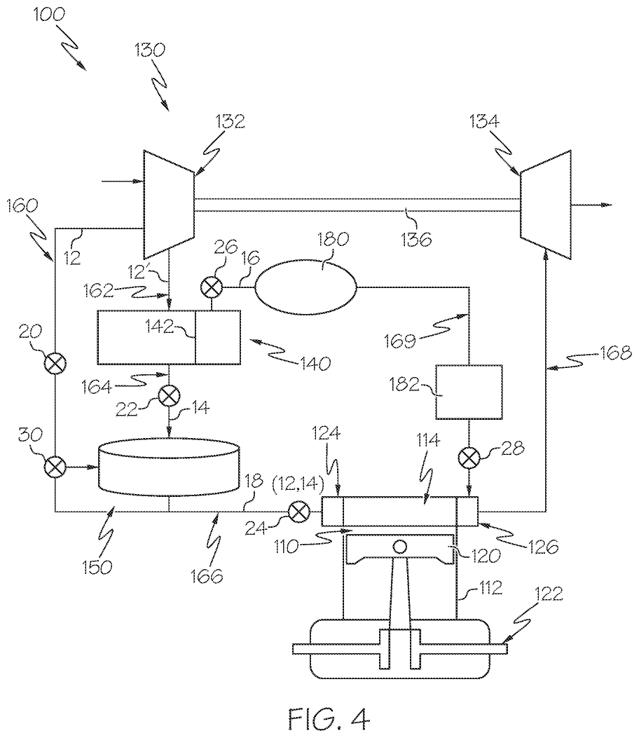

Referring to FIGS. 2 and 4, another embodiment of the internal combustion engine 100 is schematically depicted. Similar to the embodiments described above and depicted in FIGS. 1 and 3, the internal combustion engine 100 includes the compression system 130, the combustion chamber 110, the separation unit 140, and the mixing chamber 150. Similar to the embodiment depicted in FIG. 3, the internal combustion engine 100 includes the oxygen conduit 169 extending from the separation unit 140. However, in the embodiment depicted in FIGS. 2 and 4, the oxygen conduit 169 extends between the separation unit 140 and the exhaust manifold 126. In the embodiment depicted in FIGS. 2 and 4, the oxygen-enriched air stream 16 may be passed to the exhaust manifold 126 from the separation unit 140, for example via the oxygen stream control device 182. In embodiments, the controller 170, the oxygen stream control device 182, and the rotational sensor 184 may coordinate the passage of the oxygen-enriched air stream 16 into the exhaust manifold 126, as described in greater detail herein.

Similar to the embodiment described above and depicted in FIG. 3, by passing the oxygen-enriched air stream 16 to the exhaust manifold 126, oxygen within the oxygen-enriched air stream 16 may encourage the oxidation of unburnt HCs and/or soot, thereby assisting in minimizing pollutants emitted by the internal combustion engine 100. However, the pressure at which the oxygen-enriched air stream 16 to the exhaust manifold 126 may be reduced as compared to embodiments in which the oxygen-enriched air stream 16 is passed to the combustion chamber 110. Accordingly, in embodiments in which the oxygen-enriched air stream 16 is passed to the exhaust manifold 126, a size of the oxygen stream compressor 180 may reduced as compared to embodiments in which the oxygen-enriched air stream 16 is passed to the combustion chamber 110, thereby reducing the cost and complexity of the internal combustion engine 100.

Further, by passing the oxygen-enriched air stream 16 to the exhaust manifold 126, the oxygen-enriched air stream 16 may have minimal impact on combustion within the combustion chamber 110. For example, the timing of the passing of the oxygen-enriched air stream 16 with respect to the position of the piston 120 may have minimal or no impact on the combustion within the combustion chamber 110, as compared to embodiments in which the oxygen-enriched air stream 16 is passed to the combustion chamber 110. Accordingly, the complexity of internal combustion engines 100 in which the oxygen-enriched air stream 16 is passed to the exhaust manifold 126 may be reduced as compared to internal combustion engines in which the oxygen-enriched air stream 16 is passed to the combustion chamber 110.

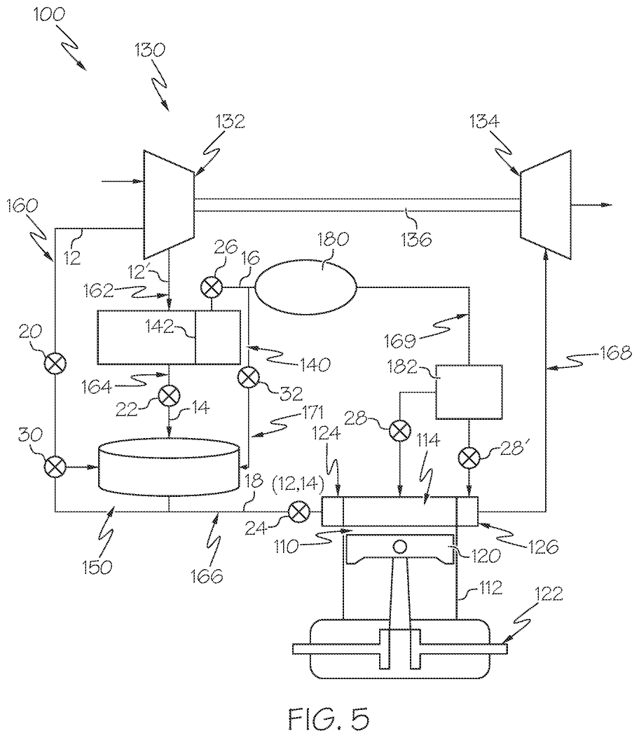

Referring to FIGS. 2 and 5, another embodiment of the internal combustion engine 100 is schematically depicted. Similar to the embodiments described above and depicted in FIGS. 1, 3, and 4, the internal combustion engine 100 includes the compression system 130, the combustion chamber 110, the separation unit 140, and the mixing chamber 150. However, in the embodiment depicted in FIGS. 2 and 5, the internal combustion engine 100 defines a mixing oxygen conduit 171 in selective communication with the mixing chamber 150. Through the mixing oxygen conduit 171, the oxygen-enriched air stream 16 can selectively be passed to the mixing chamber 150. In some embodiments, the internal combustion engine 100 further includes a mixing oxygen valve 32. The mixing oxygen valve 32, in some embodiments, is positionable between an open position and a closed position. In the open position, at least a portion of the oxygen-enriched air stream 16 is directed to the mixing chamber 150 through the mixing oxygen valve 32. In the closed position, the oxygen-enriched air stream 16 is restricted from passing to the mixing chamber 150 through the mixing oxygen valve 32.

In some embodiments, the controller 170 directs mixing oxygen valve 32 to move from the open position to the closed position in response to receiving a signal from the nitrogen concentration sensor 186 indicative of a detected nitrogen content in the nitrogen-enriched air stream 14 below a lower configurable threshold. In some embodiments, the lower configurable threshold is about 79.5% nitrogen by volume. In some embodiments, the lower configurable threshold is greater than about 79.5% nitrogen by volume. In some embodiments, the lower configurable threshold is between about 79.5% and about 89.0% by volume, inclusive of the endpoints.

In some embodiments, in response to the receiving a signal from the nitrogen concentration sensor 186 indicative of a detected nitrogen content in the nitrogen-enriched air stream 14 exceeding an upper configurable threshold, the controller 170 directs mixing oxygen valve 32 to move from the closed position to the open position. In some embodiments, the upper configurable threshold is about 89.0% by volume. In some embodiments, the upper configurable threshold is less than about 89.0% nitrogen by volume. In some embodiments, the upper configurable threshold is between about 79.5% and about 89.0% by volume, inclusive of the endpoints.

By moving the mixing oxygen valve 32 between the open position and the closed position, the oxygen-enriched air stream 16 may be selectively directed to the mixing chamber 150 to mix with the nitrogen-enriched air stream 14, thereby selectively diluting the nitrogen concentration of gas passed to the combustion chamber 110. In a similar fashion to the compressed air valve 30, the selective movement of the mixing oxygen valve 32 may maintain the nitrogen concentration in gas passed to the combustion chamber 110 between the upper configurable threshold and the lower configurable threshold.

In some embodiments, as shown in FIG. 5, the oxygen conduit 169 is in communication with the combustion chamber 110 and the exhaust manifold 126. In these embodiments, the oxygen stream control device 182 may selectively direct the oxygen-enriched air stream 16 to the combustion chamber 110 and/or the exhaust manifold 126. In the embodiment depicted in FIG. 5, the internal combustion engine 100 includes first valve 28 positioned between the oxygen stream control device 182 and the combustion chamber 110 and a second valve 28′ positioned between the oxygen stream control device 182 and the exhaust manifold 126. In embodiments, the first and second valves 28, 28′ may be check valves that allow the oxygen-enriched air stream 16 to flow from the oxygen stream control device 182 to the combustion chamber 110 and the exhaust manifold 126, while restricting the flow of gas from the combustion chamber 10 and the exhaust manifold 126 to the oxygen stream control device 182, respectively.

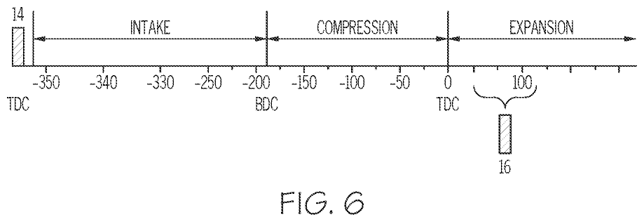

Referring to FIGS. 2, 3, 4, 5, and 6 a timing chart for the injection of the oxygen-enriched air stream 16 into the combustion chamber 110 and/or into the exhaust manifold 126 is depicted. In embodiments, the oxygen-enriched air stream 16 may be passed into the combustion chamber 110 and/or into the exhaust manifold 126, for example, late in the combustion cycle during the expansion stroke or exhaust stroke. For example, in some embodiments, the oxygen-enriched air stream 16 may be passed to the combustion chamber 110 or the exhaust manifold 126 between about 20 degrees after Top Dead Center (aTDC) and about 120 aTDC. In some embodiments, the oxygen-enriched air stream 16 is injected for a duration of about 100 degrees. By injecting the oxygen-enriched air stream 16 during the expansion stroke or exhaust stroke, the oxygen-enriched air stream 16 may have minimal effect on combustion temperature within the combustion chamber 110. For example, injection of the oxygen-enriched air stream 16 may generally increase the oxygen content within the combustion chamber 110. However, the increased oxygen content resulting from the oxygen-enriched air stream 16, in embodiments, has minimal impact on the combustion temperature within the combustion chamber 110 because the oxygen-enriched air stream is injected during the expansion stroke or exhaust stroke (e.g., late in the combustion cycle).

By injecting the oxygen-enriched air stream 16 into the combustion chamber 110 or the exhaust manifold 126, oxygen within the oxygen-enriched air stream 16 may oxidize unburnt HCs and/or soot, thereby reducing the emission of unburnt HCs and/or soot from the internal combustion engine 100.

In some embodiments, at least a portion of the oxygen-enriched air stream 16 can be injected into the combustion chamber 110 or the intake manifold 124 during the intake stroke. For example, at least a portion of the oxygen-enriched air stream 16 may be injected into the combustion chamber 110 or the intake manifold 124 in embodiments in which the internal combustion engine 100 is operating under a spark ignition mode. By injecting at least a portion of the oxygen-enriched air stream 16 into the combustion chamber 110 or the intake manifold 124 during the intake stroke, flame propagation within the combustion chamber 110 may be increased, thereby reducing engine knock. As described herein, “knock” refers to the irregular combustion of a gas/fuel mixture within the combustion chamber 110. For example, knock may occur by the combustion of the gas/fuel mixture by pre-ignition, such as may result from hot-spots within the combustion chamber 110. Selective injection of at least a portion of the oxygen-enriched air stream 16 during the intake stroke may encourage flame propagation through the combustion chamber 110, which may subsume pre-ignition events within the combustion chamber 110.

Accordingly, it should now be understood that embodiments of the present disclosure are directed to internal combustion engines that include a separation unit that separates nitrogen from air, forming a nitrogen-enriched air stream. The nitrogen-enriched air stream may be mixed with air and passed to a combustion chamber and combusted. By increasing the nitrogen in the combustion chamber, a temperature of the combustion can be reduced, thereby reducing the production of NOx. In some embodiments, the separation unit further produces an oxygen-enriched air stream that can be passed to the combustion chamber or an exhaust manifold. Oxygen within the oxygen-enriched air stream may oxidize unburnt HCs and soot. In this way, internal combustion engines according to the present disclosure may have reduced emissions, even while utilizing heavy fuel oil and/or other marine fuels.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the appended claims should be taken as the sole representation of the breadth of the present disclosure and the corresponding scope of the various embodiments described in this disclosure. Further, it should be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the appended claims and their equivalents.

It is noted that recitations herein of a component of the present disclosure being “structurally configured” in a particular way, to embody a particular property, or to function in a particular manner, are structural recitations, as opposed to recitations of intended use. More specifically, the references herein to the manner in which a component is “structurally configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A method for operating an internal combustion engine, the method comprising:
passing air to a separation unit;
separating the air into a nitrogen-enriched air stream and an oxygen-enriched air stream with the separation unit, wherein the nitrogen-enriched air stream comprises a greater concentration of nitrogen than the oxygen-enriched air stream;
passing the nitrogen-enriched air stream to a mixing chamber in communication with the separation unit;
detecting a nitrogen content within the nitrogen-enriched air stream;
based at least in part on the detected nitrogen content within the nitrogen-enriched air stream, moving an air valve between a closed position, in which the air valve restricts flow of an air stream to the mixing chamber, and an open position, in which the air stream flows to the mixing chamber through the air valve;
passing the nitrogen-enriched air stream to a combustion chamber;
passing a fuel to the combustion chamber; and
combusting the fuel and the nitrogen-enriched air stream within the combustion chamber, thereby moving a piston within the combustion chamber.

2. The method of claim 1, further comprising mixing the nitrogen-enriched air stream with the air stream within the mixing chamber to form a mixed stream, and passing the mixed stream from the mixing chamber to the combustion chamber.

3. The method of claim 1, further comprising moving the air valve from an engine intake position, in which a compressor is in communication with the combustion chamber, to a mixing position, in which the compressor is in communication with the mixing chamber.

4. The method of claim 1, further comprising moving the air valve from the closed position to the open position in response to detecting a nitrogen concentration within the nitrogen-enriched air stream exceeds an upper configurable threshold.

5. The method of claim 4, wherein the upper configurable threshold comprises about 89.0% nitrogen by volume.

6. The method of claim 1, further comprising moving the air valve from the open position to the closed position in response to detecting a nitrogen concentration within the nitrogen-enriched air stream is below a lower configurable threshold.

7. The method of claim 6, wherein the lower configurable threshold is about 79.5% nitrogen by volume.

8. The method of claim 1, further comprising moving a mixing oxygen valve between an open position, in which at least a portion of the oxygen-enriched air stream passes to the mixing chamber through the mixing oxygen valve, and a closed position, in which the oxygen-enriched air stream is restricted from passing to the mixing chamber through the mixing oxygen valve.

9. The method of claim 8, further comprising moving the mixing oxygen valve from the open position to the closed position in response to detecting a nitrogen concentration within the nitrogen-enriched air stream is below a lower configurable threshold.

10. The method of claim 8, further comprising moving the mixing oxygen valve from the closed position to the open position in response to detecting a nitrogen concentration within the nitrogen-enriched air stream is above an upper configurable threshold.

11. The method of claim 1, further comprising passing the oxygen-enriched air stream to at least one of the combustion chamber and an exhaust manifold in selective communication with the combustion chamber.

12. The method of claim 11, further comprising oxidizing at least a portion of unburnt hydrocarbons from the fuel with the oxygen-enriched air stream.

13. The method of claim 11, further comprising compressing the oxygen-enriched air stream prior to passing the oxygen-enriched air stream to the at least one of the exhaust manifold and the combustion chamber.

14. The method of claim 1, further comprising passing the oxygen-enriched air stream to the combustion chamber during an expansion stroke or exhaust stroke.

15. The method of claim 1, further comprising passing the oxygen-enriched air stream to the combustion chamber during an intake stroke.

16. The method of claim 1, further comprising, prior to separating the air into the nitrogen-enriched air stream and the oxygen-enriched air stream with the separation unit, performing a startup procedure comprising passing air to the combustion chamber through the air valve.

17. The method of claim 1, wherein the fuel comprises heavy fuel oil.

18. A method for operating an internal combustion engine, the method comprising:
passing air to a separation unit;
separating the air into a nitrogen-enriched air stream and an oxygen-enriched air stream with the separation unit, wherein the nitrogen-enriched air stream comprises a greater concentration of nitrogen than the oxygen-enriched air stream;
passing the nitrogen-enriched air stream to a mixing chamber;
mixing the nitrogen-enriched air stream with air within the mixing chamber to form a mixed stream;
passing the mixed stream from the mixing chamber to a combustion chamber;
passing a fuel to the combustion chamber; and
combusting the fuel and the mixed stream within the combustion chamber.

19. The method of claim 18, further comprising passing the oxygen-enriched air stream to at least one of the combustion chamber and an exhaust manifold in selective communication with the combustion chamber.

20. The method of claim 19, further comprising oxidizing at least a portion of unburnt hydrocarbons with the oxygen-enriched air stream.

21. The method of claim 19, further comprising compressing the oxygen-enriched air stream prior to passing the oxygen-enriched air stream to the at least one of the exhaust manifold and the combustion chamber.

22. The method of claim 18, further comprising, prior to passing the air to the separation unit, compressing the air.

23. An internal combustion engine comprising:
a combustion chamber;
a separation unit in selective communication with the combustion chamber, the separation unit structurally configured to separate air into a nitrogen-enriched air stream and an oxygen-enriched air stream;
a compressor in communication with the separation unit;
a mixing chamber in communication with the separation unit and in selective communication with the compressor;
an air valve in communication with the compressor, wherein the air valve is positionable between a bctwccn a closed position, in which the air valve restricts flow of an air stream from the compressor to the mixing chamber, and an open position, in which the air stream flows to the mixing chamber through the air valve;
a nitrogen concentration sensor structurally configured to detect a nitrogen content in the nitrogen-enriched air stream; and
a controller communicatively coupled to the air valve and the nitrogen concentration sensor, the controller comprising a processor and a computer readable and executable instruction set, which when executed, causes the processor to:
receive a signal from the nitrogen concentration sensor indicative of a detected nitrogen content in the nitrogen-enriched air stream; and
direct the air valve to move between the closed position and the open position based at least in part on the signal from the nitrogen concentration sensor.

24. The internal combustion engine of claim 23, further comprising:
an exhaust manifold in selective communication with the combustion chamber; and
an oxygen conduit extending between the separation unit and the exhaust manifold, wherein the oxygen-enriched air stream selectively flows from the separation unit to the exhaust manifold through the oxygen conduit.

25. The internal combustion engine of claim 23, further comprising an oxygen stream compressor in communication with the separation unit, wherein the oxygen stream compressor is structurally configured to compress the oxygen-enriched air stream.

26. The internal combustion engine of claim 23, further comprising:
an oxygen stream control device positioned between the separation unit and the combustion chamber;
a crankshaft coupled to a piston, the piston at least partially defining the combustion chamber;
a rotational sensor structurally configured to detect a rotational position of the crankshaft; and
wherein the executable instruction set, when executed, further causes the processor to:
receive a signal from the rotational sensor indicative of a detected rotational position of the crankshaft;
determine whether the detected rotational position of the crankshaft is indicative of whether the piston is in an expansion stroke or exhaust stroke; and
in response to determining that the detected rotational position of the crankshaft indicates that the piston is in the expansion stroke or exhaust stroke, direct the oxygen stream control device to direct the oxygen-enriched air stream to at least one of the combustion chamber and an exhaust manifold.

27. The internal combustion engine of claim 23, further comprising:
an oxygen stream control device positioned between the separation unit and the combustion chamber;
a crankshaft coupled to a piston, the piston at least partially defining the combustion chamber;
a rotational sensor structurally configured to detect a rotational position of the crankshaft; and
wherein the executable instruction set, when executed, further causes the processor to:
receive a signal from the rotational sensor indicative of a detected rotational position of the crankshaft;
determine whether the detected rotational position of the crankshaft is indicative of whether the piston is in an intake stroke; and
in response to determining that the detected rotational position of the crankshaft indicates that the piston is in the intake stroke, direct the oxygen stream control device to direct the oxygen-enriched air stream to at least one of the combustion chamber and an exhaust manifold.

28. The internal combustion engine of claim 23, wherein the separation unit comprises a membrane structurally configured to separate nitrogen from air.

29. The internal combustion engine of claim 23, further comprising one or more check valves positioned between the compressor and the combustion chamber.
